(19) United States
(12) Patent Application Publication
(10) Pub. No.: US 2017/0276941 A1
(43) Pub. Date: Sep. 28, 2017

(54) HEAD MOUNTED DISPLAY

(71) Applicant: KYOCERA Corporation, Kyoto-shi (JP)

(72) Inventors: Kouichirou FUJIHARA, Yokohama-shi (JP); Keisuke OKADA, Yokohama-shi (JP); Yoshiteru KUROSAKI, Yokohama-shi (JP); Tomohiro DEGAWA, Tokyo (JP); Jun MATSUZAWA, Kawasaki-shi (JP); Susumu OZAWA, Ebina-shi (JP); Shingo ITO, Kawasaki-shi (JP)

(21) Appl. No.: 15/469,890

(22) Filed: Mar. 27, 2017

(30) Foreign Application Priority Data
Mar. 28, 2016 (JP) 2016-064381

(51) Int. Cl. G02B 27/01; G06F 3/06

(52) U.S. Cl. CPC G02B 27/017; G06F 3/0605; G06F 3/0632; G02B 2027/0178; G02B 2027/0192

(57) ABSTRACT

There is provided a head mounted display comprising: an interface unit configured to be connected with a cartridge which stores an execution condition for an unmounting process for the cartridge; and at least one controller configured to perform, when the execution condition is satisfied, the unmounting process for the cartridge while the cartridge is connected to the interface unit.

### CROSS-REFERENCE TO RELATED APPLICATION

The present application claims priority to and incorporates by reference the entire contents of Japanese Patent Application No. 2016-064381 filed in Japan on Mar. 28, 2016.

### FIELD

The present application relates to a head mounted display.

### BACKGROUND

As a display device, there is provided a display device which is to be mounted on a head of a user.

A display device to be mounted on a head of a user having enhanced usability is desired.

### SUMMARY

A head mounted display is disclosed.

According to one aspect, there is provided a head mounted display comprising: an interface unit configured to be connected with a cartridge which stores an execution condition for an unmounting process for the cartridge; and at least one controller configured to perform, when the execution condition is satisfied, the unmounting process for the cartridge while the cartridge is connected to the interface unit.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating a schematic external configuration of a head mounted display according to embodiments;

FIG. 2 is a block diagram illustrating an example of a functional configuration of the head mounted display according to embodiments;

FIG. 3 is a diagram illustrating an example of an installation position of an interface unit according to embodiments;

FIG. 4 is a diagram illustrating another example of the installation position of the interface unit according to embodiments;

FIG. 5 is a diagram illustrating an example of a direction of an opening of the interface unit according to embodiments;

FIG. 6 is a diagram illustrating another example of the installation position and the direction of the opening of the interface unit according to embodiments;

FIG. 7 is a diagram illustrating other example of the installation position and the direction of the opening of the interface unit according to embodiments;

FIG. 8 is a view illustrating an example of control of the head mounted display according to embodiments;

FIG. 9 is a view illustrating another example of control of the head mounted display according to embodiments; and

FIG. 10 is a flowchart illustrating an example of a process of control by the head mounted display according to embodiments.

### DETAILED DESCRIPTION OF THE PREFERRED EMBODIMENTS

Embodiments of a head mounted display according to the present application will be described in detail with reference to the drawings. A user of the head mounted display according to the present application may receive various services through the head mounted display by connecting an externally connectable cartridge to the head mounted display and loading specific contents into the head mounted display from the cartridge. A cartridge that can be externally connected to the head mounted display may be provided by various indoor/outdoor facilities and the like capable of providing services through the head mounted display, including a business park, a shopping center, a fashion mall, a park, an amusement park, a high-technology park, a home and the like.

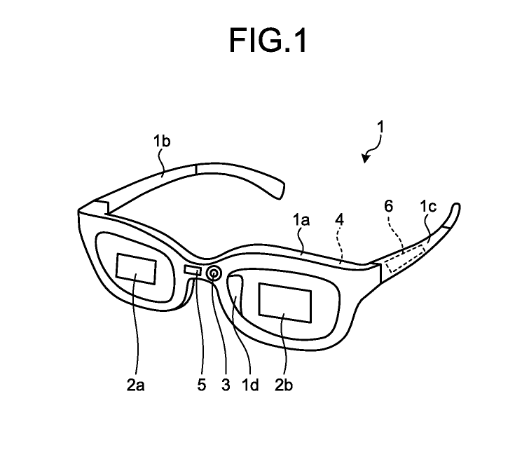

FIG. 1 is a diagram illustrating a schematic external configuration of the head mounted display according to embodiments. As illustrated in FIG. 1, a head mounted display 1 is shaped as eyeglasses, and includes a front 1a, a temple 1b, a temple 1c, and a nose pad 1d. The shape of the head mounted display 1 illustrated in FIG. 1 is merely an example, and the head mounted display 1 is not limited to the shape illustrated in FIG. 1 as long as functions of a wearable terminal to be mounted on a head can be realized.

The front 1a is formed to at least partially surround outer circumferential portions of a display 2a and a display 2b. The front 1a is a part that comes in front of eyes of a user of the head mounted display 1 when the head mounted display 1 is worn by the user. The nose pad 1d includes a pair of pads (not illustrated), and contacts a nose of the user of the head mounted display 1 by pinching the nose when the head mounted display 1 is worn by the user. The nose pad 1d contributes to support the head mounted display 1 worn by the user in such a manner that the head mounted display 1 does not slip off a face of the user in the gravitational direction and its mounted attitude is maintained as much as possible.

An imager 3, an imager 4, a detector 5, an operation unit 6 and the like are also installed at the front 1a.

The temple 1b and the temple 1c are formed to have the same bar shape. The temple 1b and the temple 1c are parts which are arranged along sides of the head of the user of the head mounted display 1 when the head mounted display 1 is worn by the user. One end portion of the temple 1b and one end portion of the temple 1c are parts which are connected to the front 1a via hinges (not illustrated) in a manner capable of being folded. The other end portion of the temple 1b and the other end portion of the temple 1c are parts which are fitted to the ears of the user of the head mounted display 1 when the head mounted display 1 is worn by the user. Like the nose pad 1d, the temple 1b and the temple 1c also contribute to support the head mounted display 1 worn by the user in such a manner that the head mounted display 1 does not slip off the face of the user in the gravitational direction and its mounted attitude is maintained as much as possible.

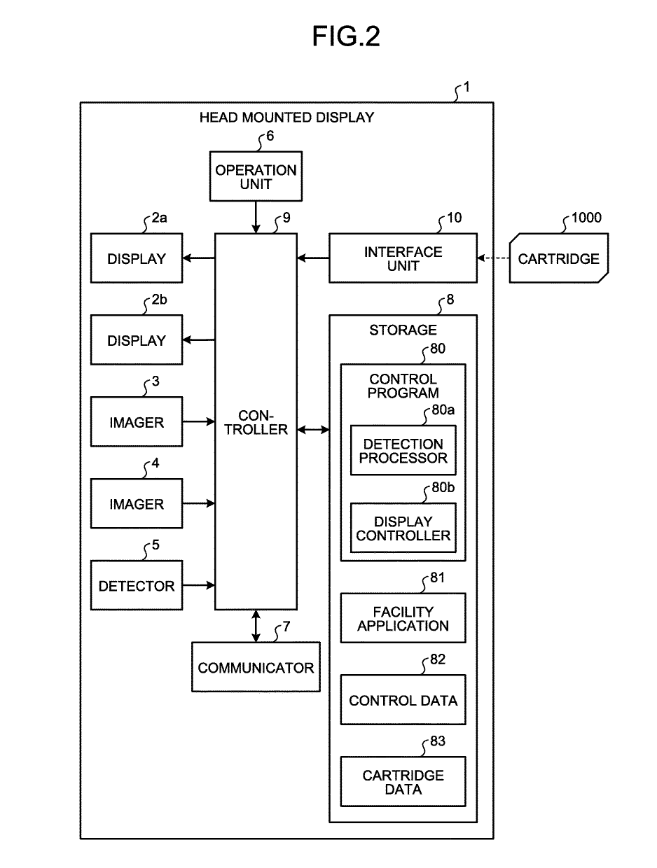

FIG. 2 is a block diagram illustrating an example of a functional configuration of the head mounted display according to embodiments.

As illustrated in FIG. 2, the head mounted display 1 is configured to include a display 2a, a display 2b, an imager 3, an imager 4, a detector 5, an operation unit 6, a communicator 7, a storage 8, a controller 9, and an interface unit 10.

Each of the display 2a and the display 2b may include a transflective or transmissive display device, such as a liquid crystal display or an organic electro-luminescence (EL) panel. The display 2a and display 2b display various pieces of information according to control signals from the controller 9. Each of the display 2a and the display 2b may be a projection device which projects images on the retinae of the user by using a light source.

Each of the imager 3 and the imager 4 electronically captures an image by an image sensor such as a charge coupled device (CCD) or a complementary metal oxide semiconductor (CMOS). Each of the imager 3 and the imager 4 converts the captured image into a signal, and outputs the signal to the controller 9. For example, the imager 3 is a front camera for capturing the view in front of the user wearing the head mounted display 1. For example, the imager 4 is a rear camera for capturing the user wearing the head mounted display 1.

The detector 5 performs various types of detection. The detector 5 is capable of detecting a detection target, a change in state of the detection target, and the like by using at least one of visible light, infrared light, ultraviolet light, radio waves, acoustic waves, magnetism, and capacitance. A detection target may be a still object, a moving object, a living object, or a non-living object. The detector 5 outputs a detection result to the controller 9. The detector 5 may include an accelerometer. The accelerometer is capable of detecting acceleration acting on the head mounted display 1. The detection result of the accelerometer may be used to detect moving and stopping of the user carrying the head mounted display 1. The detector 5 is capable of detecting a current position of the head mounted display 1. The detector 5 may detect the current position by a global positioning system (GPS) receiver. The detector 5 may alternatively detect the current position based on a base station communicated by the communicator 7 for wireless communication. The detector 5 may alternatively detect the current position by a plurality of methods in combination. The illuminance sensor can be used to detect ambient light around the head mounted display 1. The illuminance sensor is used for example to adjust brightness of the display 2a and the display 2b.

The operation unit 6 receives, from the user, operation input for activation or deactivation of the head mounted display 1, changes in various settings including operation settings, and the like. The operation unit 6 converts the operation input from the user into a signal, and outputs the signal to the controller 9.

The communicator 7 is capable of communicating with other devices. For example, the communicator 7 is capable of transmitting/receiving, by a predetermined communication protocol, various pieces of information which are to be exchanged with another head mounted display or a facility server installed in a facility. The communicator 7 is capable of establishing a communication connection to another head mounted display. One or a plurality of communication standards for short range wireless communication may be supported by the communicator 7. The communication standards for short range wireless communication include IEEE 802.11, Bluetooth (registered trademark), Infrared Data Association (IrDA), Short range Communication (NFC), and Wireless Personal Area Network (WPAN), for example.

The storage 8 stores programs, data and the like. Programs stored in the storage 8 include a control program 80. Applications stored in the storage 8 include a facility application 81. Data stored in the storage 8 include control data 82, and cartridge data 83.

The storage 8 may be used as a work area for temporarily storing a processing result of the controller 9. The storage 8 may be configured by any non-transitory storage medium such as a semiconductor storage medium or a magnetic storage medium. The storage 8 may include a plurality of types of storage media. The storage 8 may include a combination of a storage medium, such as a memory card, an optical disk or a magneto-optical disk, and a reader/writer device for the storage medium. The storage 8 may include a storage device to be used as a temporary storage area for a random access memory (RAM) or the like. Programs stored in the storage 8 may include a program (not illustrated) for supporting operation of an application. Programs stored in the storage 8 may be acquired from other devices, such as servers, by wireless or wired communication.

The control program 80 provides functions for various control by the head mounted display 1. Functions to be provided by the control program 80 include functions of a detection processor 80a, and a display controller 80b.

The detection processor 80a provides functions for performing various types of control of the head mounted display 1 based on detection results of the detector 5. The display controller 80b provides functions for performing display control for the display 2a and the display 2b. The control program 80 provides a function relating to a mounting process and an unmounting process of a cartridge 1000 connected to the interface unit 10. The mounting process includes a process to recognize the cartridge 1000 and enable the use thereof. The unmounting process includes a process to make the cartridge 1000 removable.

The facility application 81 is an application for providing functions for a user of the head mounted display 1 to use equipment or the like installed inside a facility through the head mounted display 1, for example. For example, in the case of an amusement park, the facility application 81 corresponds to an application for displaying various pieces of information regarding the amusement park, such as a map of the amusement park, or an application for outputting moving images, sound and the like at the time of the user enjoying various attractions in the amusement park. When multiple pieces of equipment are installed in a facility, the facility application 81 may be configured as an application set including applications for respective pieces of equipment. The facility application 81 may be acquired from a cartridge 1000 which is externally connected to the interface unit 10.

The control data 82 is data used for various types of control of the head mounted display 1 performed by the functions provided by the control program 80. The control data 82 may be acquired from the cartridge 1000 which is externally connected to the interface unit 10.

The cartridge data 83 is data which is acquired from the cartridge 1000 externally connected to the interface unit 10. For example, in the case of an amusement park, the cartridge data 83 is used by the facility application 81 to output moving images, sound and the like to the head mounted display 1 according to a game story.

The cartridge data 83 may include first condition information representing an execution condition for executing at least one of the mounting process and the facility application 81. For example, the head mounted display 1 sometimes has difficulty in synchronization between timing for executing the mounting process and the facility application 81, and timing for starting an attraction. The first condition information can be information for synchronization with attraction-specific start timing. For example, the first condition information includes information representing an internal event and an external event. For example, the internal event includes attraction opening time. For example, the external event includes reception of data from a gate, a return counter, or the like of an attraction facility, reception of a radio wave, or the like. For example, the external event includes detection of change of light by the illuminance sensor, detection of predetermined sound, detection of predetermined operation, detection of a predetermined position, or the like. The execution condition represented by the first condition information can be fulfilled in a single event or a combination of a plurality of events.

The cartridge data 83 includes second condition information representing an execution condition for the unmounting process. For example, the second condition information can be information representing a trigger for performing the unmounting process. For example, the second condition information includes information representing an internal event and an external event. For example, the internal event includes termination of execution of the facility application 81, ending time of an attraction, and closing time of an attraction facility. For example, the external event includes reception of data from a gate, a return counter, or the like of an attraction facility, reception of a predetermined radio wave, or the like. For example, the external event includes detection of change of light by the illuminance sensor, detection of predetermined sound, detection of predetermined operation, detection of a predetermined position, or the like. The execution condition represented by the second condition information can be fulfilled in a single event or a combination of a plurality of events.

The controller 9 includes an arithmetic processing device. The arithmetic processing device may, but not limited to, include a central processing unit (CPU), a system-on-a-chip (SoC), a micro control unit (MCU), a field-programmable gate array (FPGA), and a co-processor. The controller 9 realizes various functions by integrally controlling the operation of the head mounted display 1. Specifically, the controller 9 realizes various types of control of the head mounted display 1 by referring to the control data 82 stored in the storage 8 as necessary and executing commands included in the control program 80 stored in the storage 8.

The interface unit 10 is open to allow insertion and connection of the cartridge 1000. When the cartridge 1000 is connected, the interface unit 10 acquires data stored in the cartridge 1000 and outputs the acquired data to the controller 9.

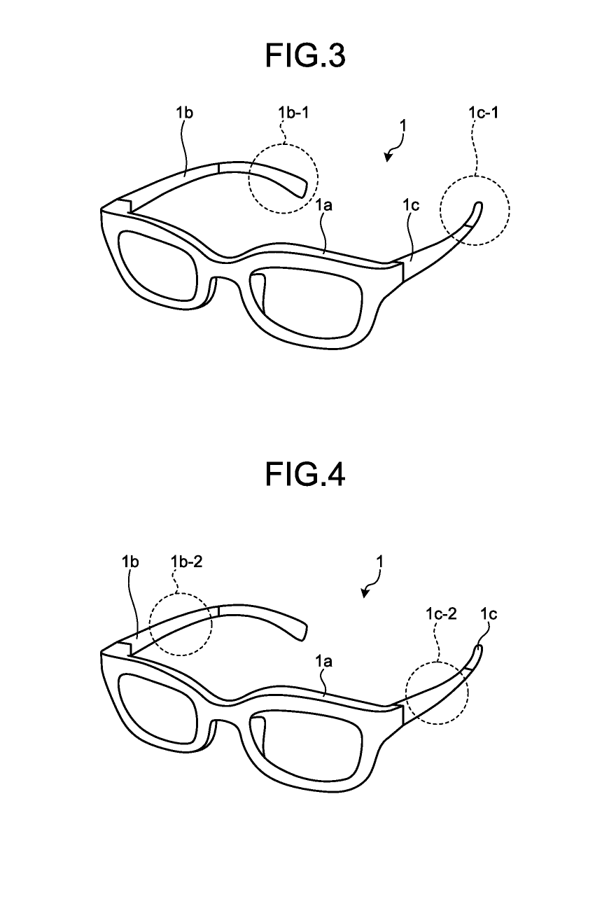

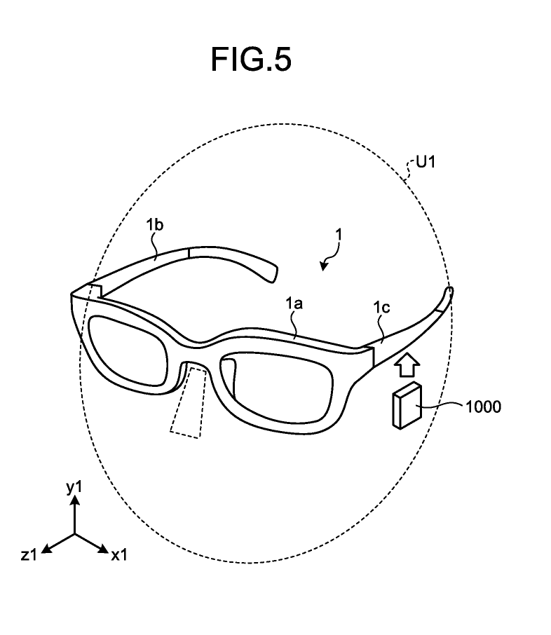

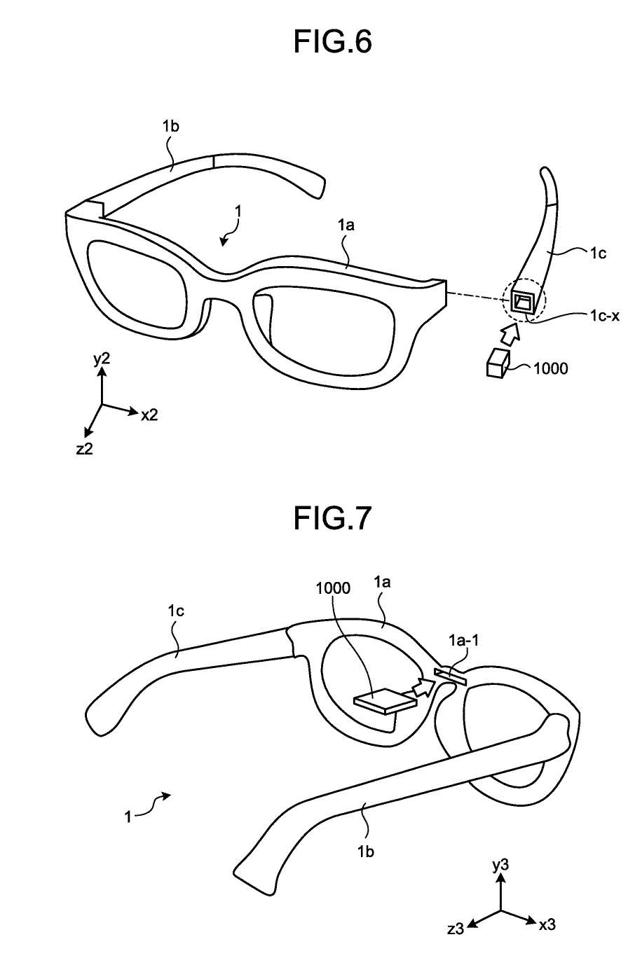

In the following, examples of an installation position and a direction of an opening of the interface unit 10 provided to the head mounted display 1 will be described with reference to FIGS. 3 to 7. FIGS. 3 and 4 are diagrams illustrating examples of the installation position of the interface unit according to embodiments. FIG. 5 is a diagram illustrating an example of the direction of the opening of the interface unit according to embodiments. FIGS. 6 and 7 are diagrams illustrating other examples of the installation position and the direction of the opening of the interface unit according to embodiments.

As illustrated in FIG. 3, the interface unit 10 may be installed to the head mounted display 1 near an end portion 1b-1 of the temple 1b which is not connected to the front 1a, and near an end portion 1c -1 of the temple 1c which is not connected to the front 1a. Alternatively, as illustrated in FIG. 4, the interface unit 10 may be installed to the head mounted display 1 near a center 1b-2 of the temple 1b, and near a center 1c-2 of the temple 1c. For example, when the front 1a is heavier than the temples 1b, 1c due to including the imager 3, the imager 4, the detector 5, the operation unit 6 and the like, a wearing feeling of the head mounted display 1 may be improved by connecting the cartridge 1000 to the temple 1b (or the temple 1c) due to making the weight of the temple 1b (or 1c) closer to the weight of the front 1a.

When the interface units 10 are installed to the temple 1b and the temple 1c, the interface units 10 are open downward in the vertical direction when the head mounted display 1 is worn by the user of the head mounted display 1. According to such a configuration, dust and the like may be prevented from entering an opening (a part which are open to the outside) of the interface unit 10 of the head mounted display 1.

The direction of the opening of the interface unit 10 will be described with reference to FIG. 5. Coordinate axes, an x1-axis, a y1-axis, and a z1-axis, illustrated in FIG. 5 are orthogonal to one another. In the example illustrated in FIG. 5, the longitudinal direction of the front 1a of the head mounted display 1 coincides with a direction that is parallel to the x1-axis among the coordinate axes illustrated in FIG. 5. The interface unit 10 is open in an orientation which allows the cartridge 1000 to be inserted and connected to the head mounted display 1. Although not clearly illustrated, in the example illustrated in FIG. 5, when the head mounted display 1 is worn by a user U1, the interface unit 10 is open downward in the vertical direction, that is, in a direction parallel to a negative direction of the yl axis.

The head mounted display 1 may have the interface unit 10 installed to each of the temple 1b and the temple 1c as illustrated in FIGS. 3 and 4, or may have the interface unit 10 installed to one of the temple 1b and the temple 1c.

Other example of the installation position and the direction of the opening of the interface unit 10 will be described with reference to FIG. 6. Coordinate axes, an x2-axis, a y2-axis, and a z2-axis, illustrated in FIG. 6 are orthogonal to one another. In the example illustrated in FIG. 6, the longitudinal direction of the front 1a of the head mounted display 1 coincides with a direction that is parallel to the x2-axis among the coordinate axes illustrated in FIG. 6. As illustrated in FIG. 6, the head mounted display 1 may have the interface unit 10 installed at a joint portion 1c-x of the temple 1c that contacts the front 1a when the temple 1c is completely opened. The interface unit 10 is open to allow insertion and connection of the cartridge 1000. In the example illustrated in FIG. 6, the interface unit 10 is illustrated in a state where it is open toward a positive direction of the z2-axis among the coordinate axes illustrated in FIG. 6. According to the head mounted display 1 of such a configuration, when the temple 1c is completely opened, the opening of the interface unit 10 is blocked by the front 1a, and the cartridge 1000 may be protected from an external impact and the like.

In the example illustrated in FIG. 6, the head mounted display 1 may be specified to include an opening which is open in the longitudinal direction of the temple 1b (or the temple 1c ) at the temple 1b (or the temple 1c).

Other examples of the installation position and the direction of the opening of the interface unit 10 will be described with reference to FIG. 7. Coordinate axes, an x3-axis, a y3-axis, and a z3-axis, illustrated in FIG. 7 are orthogonal to one another. In the example illustrated in FIG. 7, the longitudinal direction of the front 1a of the head mounted display 1 coincides with a direction that is parallel to the x3-axis among the coordinate axes illustrated in FIG. 7. As illustrated in FIG. 7, the head mounted display 1 may have the interface unit 10 installed at a region 1a-1 of the front 1a which faces a face of the user. The interface unit 10 is open to allow insertion and connection of the cartridge 1000. In the example illustrated in FIG. 7, the interface unit 10 is illustrated in a state where it is open toward a positive direction of the z3-axis among the coordinate axes illustrated in FIG. 7. According to the head mounted display 1 of such a configuration, the cartridge 1000 connected to the interface unit 10 may be protected from an external impact and the like.

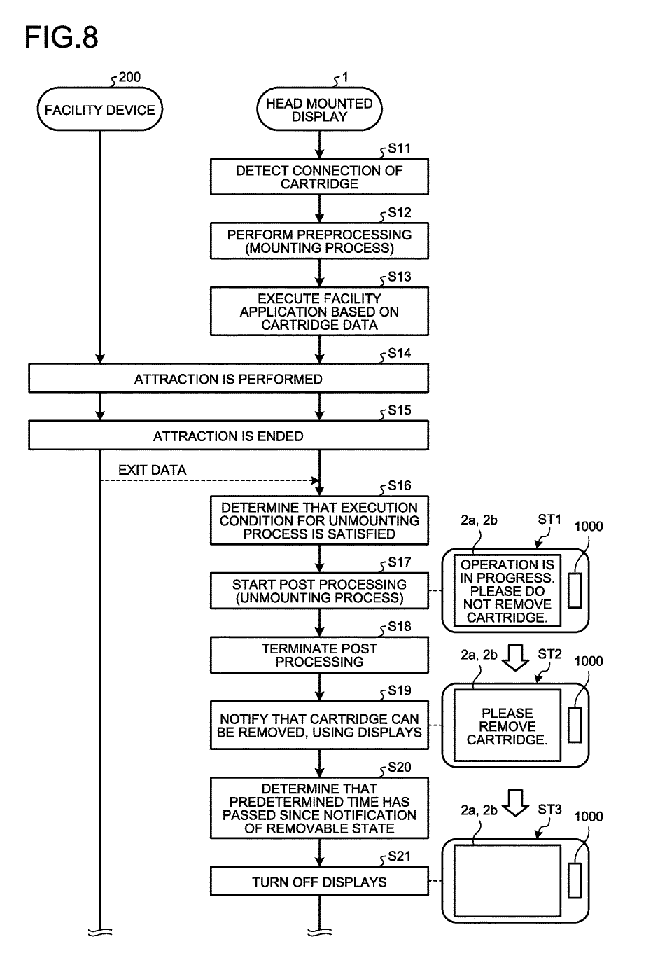

FIG. 8 is a view illustrating an example of control of the head mounted display 1 according to embodiments. An example of the control of the head mounted display 1 used for an attraction facility will be described with reference to FIG. 8.

For example, when receiving the cartridge 1000 at the attraction facility or the like, the user connects the cartridge 1000 to the interface unit 10 of the head mounted display 1. The user wears the head mounted display 1 on his/her head, and activates the head mounted display 1.

The head mounted display 1 detects the connection of the cartridge 1000 through the interface unit 10 (Step S11). For example, when reading and writing is enabled with respect to the cartridge 1000, the head mounted display 1 detects the connection of the cartridge 1000. When the connection of the cartridge 1000 is detected, the head mounted display 1 performs preprocessing (Step S12). The preprocessing includes the mounting process of the cartridge 1000, an acquisition process, a setting process, and the like. The mounting process includes a process to recognize the cartridge 1000 and enable the use thereof. The acquisition process includes a process to acquire data from the cartridge 1000. The setting process includes a process to change and activate functions of the head mounted display 1 used for an attraction based on the cartridge data 83. The head mounted display 1 acquires, and stores in the storage 8, the facility application 81 and the cartridge data 83 from the cartridge 1000 by performing the preprocessing. The preprocessing may have, for example, only the mounting process without the acquisition process and setting process.

The head mounted display 1 executes the facility application 81 based on the cartridge data 83 (Step S13). For example, after performing the preprocessing, the head mounted display 1 detects timing in synchronization with attraction-specific start timing based on the first condition information of the cartridge data 83. When the timing in synchronization with the attraction-specific start timing is detected, the head mounted display 1 executes the facility application 81. Therefore, the head mounted display 1 can execute the facility application 81 at appropriate time according to the attraction.

The head mounted display 1 executes the facility application 81 based on the cartridge data 83, and the attraction is performed (Step S14). While the attraction is performed, the head mounted display 1 performs processing in cooperation with a facility device 200 of the attraction facility. The facility device 200 includes for example a server for providing attraction service and a communication device. In the head mounted display 1, the display controller 80b causes the display 2a and the display 2b to display information according to the attraction. When the attraction ends (Step S15), the head mounted display 1 terminates execution of the facility application 81.

When the attraction ends, the user moves to a gate to go out of the attraction facility or the like. The head mounted display 1 receives exit data from the facility device 200 or the like through the communicator 7. The execution condition represented by the second condition information of the cartridge data 83 includes an event of reception of data from a gate of an attraction facility. The head mounted display 1 determines that the execution condition for the unmounting process is satisfied (Step S16) based on the second condition information of the cartridge data 83.

After a display process, the head mounted display 1 starts postprocessing (unmounting process) (Step S17). The display process includes a process to control display of a first screen for warning the user that the cartridge 1000 cannot be removed. The postprocessing includes a saving process, the unmounting process of the cartridge 1000, a setting process, and the like. The saving process includes a process to save data generated by the execution of the facility application 81 in the cartridge 1000. The saving process includes a process to write data to the cartridge 1000 by the interface unit 10. The unmounting process includes a process to make the cartridge 1000 removable. The setting processing includes a process to return the setting of the head mounted display 1 which has been changed based on the cartridge data 83 to the setting before the change. The postprocessing may include a display process. When the postprocessing is started, the head mounted display 1 shifts to a state ST1. In the state ST1, the first screen is displayed on the display 2a and the display 2b, and the cartridge 1000 is being connected to the interface unit 10. In the example illustrated in FIG. 8, the first screen is a screen displaying information “Operation is in progress. Please do not remove cartridge”.

When the cartridge 1000 is brought into a removable state, the head mounted display 1 terminates the postprocessing (Step S18). The head mounted display 1 continues the state ST1. When the postprocessing terminates, the head mounted display 1 notifies that the cartridge 1000 can be removed, using the display 2a and the display 2b (Step S19). The head mounted display 1 shifts from the state ST1 to a state ST2, according to the notification. In the state ST2, a second screen is displayed on the display 2a and the display 2b, and the cartridge 1000 is being connected to the interface unit 10. In the example illustrated in FIG. 8, the second screen is a screen displaying information “Please remove cartridge”.

The head mounted display 1 continues the state ST2. The head mounted display 1 determines that a predetermined time period has passed since the notification of the removable state (Step S20). The predetermined time period includes for example a time period required for turning off the display 2a and the display 2b. The predetermined time period includes for example a time period based on power consumption of the head mounted display 1, a time period set by the attraction facility, or the like. When it is determined that the predetermined time period has passed, the head mounted display 1 turns off the display 2a and the display 2b (Step S21). After the display 2a and the display 2b are turned off, the head mounted display 1 shifts from the state ST2 to a state ST3. In the state ST3, the display 2a and the display 2b are turned off, and the cartridge 1000 is being connected to the interface unit 10. For example, when the display 2a and the display 2b are turned off, the head mounted display 1 is ready for removal of the cartridge 1000 by the user.

As described above, when the execution condition is satisfied while the cartridge 1000 is connected to the interface unit 10, the head mounted display 1 can perform the unmounting process on the cartridge 1000. Consequently, the possibility of disconnection of the cartridge 1000 during the unmounting process is reduced, and the head mounted display 1 can normally save data in the cartridge 1000. The head mounted display 1 performs the unmounting process based on the execution condition stored in the cartridge 1000, and the unmounting process can be automatically started without requiring user's operation. Thus, usability of the head mounted display 1 with the cartridge 1000 being connected to the interface unit 10 can be improved.

For example, in some attraction facilities, the cartridge 1000 is lent to the user, and returned at the end of an attraction. The head mounted display 1 is configured so that the cartridge 1000 and the interface unit 10 can be disconnected by the user after the unmounting process terminates. Thus, according to the head mounted display 1, the cartridge 1000 in which no improper data is saved can be returned to the attraction facility.

For example, the execution condition can include at least one of termination of execution of an application in the cartridge 1000, ending time of an attraction, closing time of the attraction, and reception of ending information of the attraction. In this configuration, after the unmounting process which is performed based on the execution condition terminates, the head mounted display 1 can prompt the user to remove the cartridge 1000.

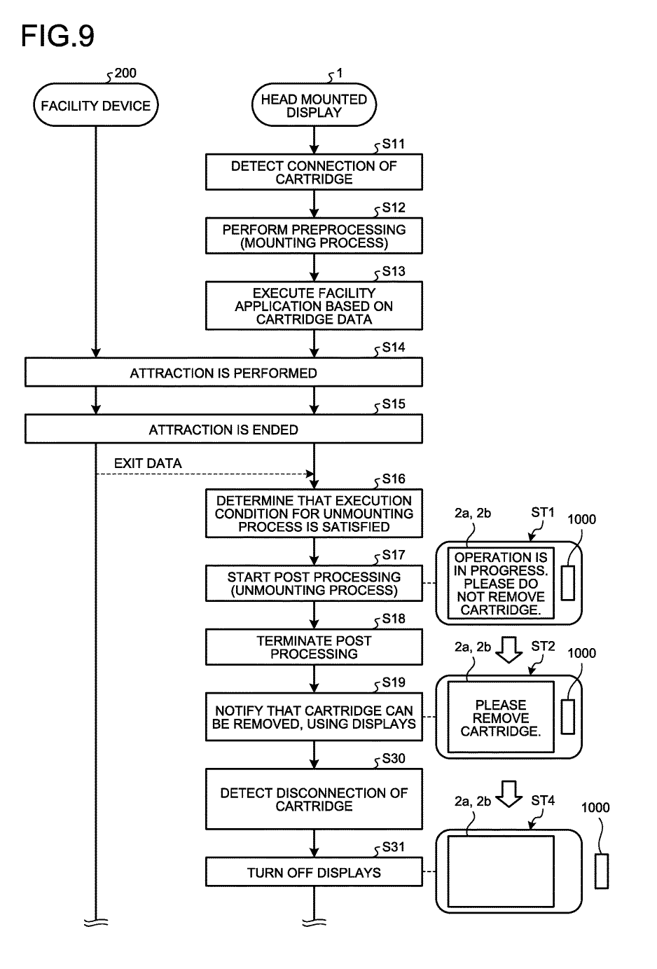

FIG. 9 is a view illustrating another example of control of the head mounted display 1 according to embodiments. Another example of the control of the head mounted display 1 used for an attraction facility will be described with reference to FIG. 9. In the following description, similar component elements are denoted by the same reference signs, and repetitive description may be omitted.

In the example illustrated in FIG. 9, each process from Step S11 to Step S19 is the same as the process from Step S11 to Step S19 illustrated in FIG. 8, therefore, a description will be given of only different points, and a repetitive description of the same points will be omitted.

When the postprocessing terminates, the head mounted display 1 notifies that the cartridge 1000 can be removed, using the display 2a and the display 2b (Step S19). The head mounted display 1 shifts from the state ST1 to a state ST2, according to the notification. In the state ST2, the user is prompted by the second screen displayed on the display 2a and the display 2b to remove the cartridge 1000 from the head mounted display 1.

The head mounted display 1 detects disconnection of the cartridge 1000 through the interface unit 10 (Step S30). The disconnection of the cartridge 1000 includes for example removal of the cartridge 1000 from the interface unit 10 by the user. For example, when data reading and writing is disabled with respect to the cartridge 1000, the head mounted display 1 detects the disconnection of the cartridge 1000. When the disconnection is detected, the head mounted display 1 turns off the display 2a and the display 2b (Step S31). The head mounted display 1 shifts from the state ST2 to a state ST4, after turning off the display 2a and the display 2b. In the state ST4, the display 2a and the display 2b are turned off, and the cartridge 1000 and the interface unit 10 are disconnected from each other. For example, when the display 2a and the display 2b are turned off, the head mounted display 1 is ready for connection of another cartridge 1000 corresponding to a next attraction.

As described above, the head mounted display 1 can notify the user of the removal of the cartridge 1000, until the disconnection between the interface unit 10 and the cartridge 1000 is detected. After the unmounting process terminates, the head mounted display 1 can display the notification on the second screen, until the cartridge 1000 is removed. Thus, the user can surely remove the cartridge 1000 from the head mounted display 1. For example, when the cartridge 1000 must to be returned to the attraction facility, the head mounted display 1 may prompt returning of the cartridge 1000 using the second screen.

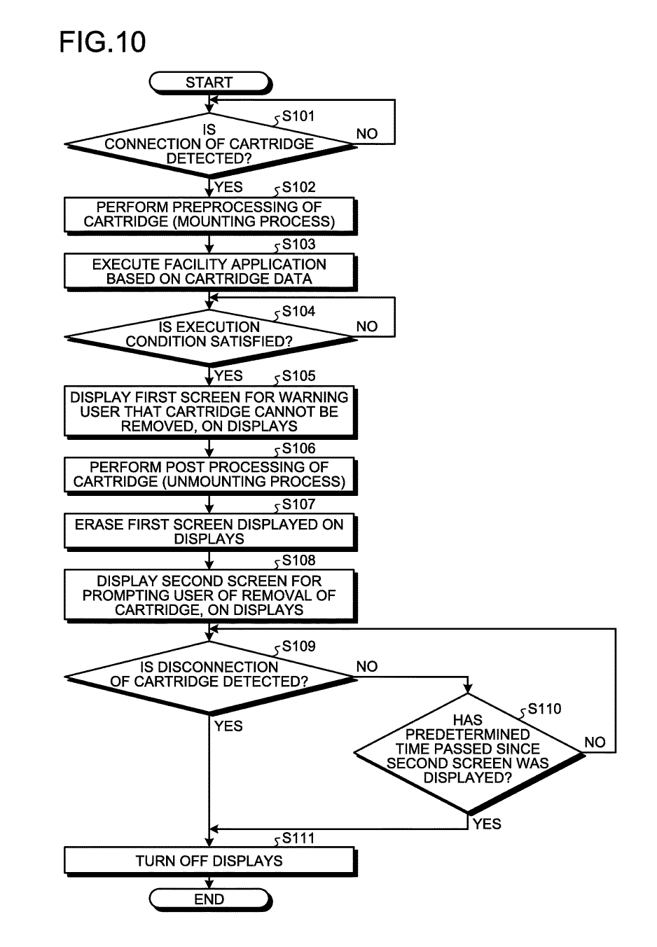

FIG. 10 is a flowchart illustrating an example of a process of control by the head mounted display 1 according to embodiments. The process illustrated in FIG. 10 can be achieved by the controller 9 executing the control program 80.

As illustrated in FIG. 10, at Step S101, the controller 9 of the head mounted display 1 determines whether the connection of the cartridge 1000 is detected, through the interface unit 10. For example, when data reading and writing is enabled with respect to the cartridge 1000, the controller 9 determines detection of the connection of the cartridge 1000. When the controller 9 determines that the connection of the cartridge 1000 is not detected (Step S101, No), the process of Step S101 is repeated. When the controller 9 determines that the connection of the cartridge 1000 is detected (Step S101, Yes), the process proceeds to Step S102.

At Step S102, the controller 9 performs preprocessing (mounting process) of the cartridge 1000. When the controller 9 terminates the preprocessing, the process proceeds to Step S103. AT Step S103, the controller 9 executes the facility application 81 based on the cartridge data 83. The facility application 81 based on the cartridge data 83 includes for example use of the cartridge data 83 by the facility application 81, output of the cartridge data 83 by the facility application 81. The controller 9 executes the facility application 81 to output for example a still image, a moving image, sound, and sound effect to the head mounted display 1, based on the cartridge data 83. After executing the facility application 81 terminates, the controller 9 proceeds to Step S104.

At Step S104, the controller 9 determines whether execution condition for unmounting process is satisfied. For example, when an event represented by the second condition information of the cartridge data 83 is generated, the controller 9 determines that the execution condition is satisfied. When the controller 9 determines that the execution condition is not satisfied (Step S104, No), the process of Step S104 is repeated. When the controller 9 determines that the execution condition is satisfied (Step S104, Yes), the process proceeds to Step S105.

At Step S105, the controller 9 displays the first screen for warning the user that the cartridge 1000 cannot be removed, on the display 2a and the display 2b. AT Step S106, the controller 9 performs the postprocessing of the cartridge 1000 (the unmounting process). In the example illustrated in FIG. 10, Step S105 and Step S106 are separated each other, but Step S105 and Step S106 are not limited thereto. For example, the process of Step S105 may be included in the process of Step S106. When the controller 9 terminates the postprocessing, the process proceeds to Step S107.

At Step S107, the controller 9 erases the first screen displayed on the display 2a and the display 2b. At Step S108, the controller 9 displays the second screen prompting the user of removal of the cartridge 1000, on the display 2a and the display 2b. After the controller 9 displays the second screen on the display 2a and the display 2b, the process proceeds to Step S109.

At Step S109, the controller 9 determines whether the disconnection of the cartridge 1000 is detected, through the interface unit 10. For example, when data reading and writing is disabled with respect to the cartridge 1000, the controller 9 determines the detection of the disconnection of the cartridge 1000. When the controller 9 determines that the disconnection of the cartridge 1000 is not detected (Step S109, No), the process proceeds to Step S110.

At Step S110, the controller 9 determines whether a predetermined time period has passed after the second screen is displayed. For example, when a time period between the starting time of the display of the second screen and the current time exceeds the predetermined time period, the controller 9 determines that the predetermined time period has passed. When the controller 9 determines that the predetermined time period has not passed (Step S110, No), the process returns to Step S109 described above. When the controller 9 determines that the predetermined time period has passed (Step S110, Yes), the process proceeds to Step S111. At Step S111, the controller 9 turns off the display 2a and the display 2b. When the controller 9 turns off the display 2a and the display 2b, the process illustrated in FIG. 10 terminates.

When the controller 9 determines that the disconnection of the cartridge 1000 is detected (Step S109, Yes), the process proceeds to Step S111 described above. At Step S111, the controller 9 turns off the display 2a and the display 2b. When the controller 9 turns off the display 2a and the display 2b, the process illustrated in FIG. 10 terminates.

In embodiments, a description has been given of the head mounted display 1 configured so that when the cartridge 1000 is removed, the display 2a and the display 2b are turned off, but the head mounted display 1 is not limited thereto. For example, when the cartridge 1000 is removed, the head mounted display 1 may turn off power of the head mounted display 1.

In embodiments described above, a case is described where the head mounted display 1 acquires the facility application 81 from the cartridge 1000; however, embodiments are not limited thereto. For example, the head mounted display 1 may acquire the facility application 81 from a server on the attraction facility side through the communicator 7.

In embodiments, configurations and operations of the head mounted display 1 has been described, but the head mounted display 1 is not limited thereto, and may be configured as a method including respective component elements.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head mounted display comprising:
an interface unit configured to be connected with a cartridge which stores an execution condition for an unmounting process for the cartridge; and
at least one controller configured to perform, when the execution condition is satisfied, the unmounting process for the cartridge while the cartridge is connected to the interface unit.

2. The head mounted display according to claim 1, wherein
the execution condition can include at least one of termination of execution of an application in the cartridge, ending time of an attraction, closing time of the attraction, reception of ending information of the attraction.

3. The head mounted display according to claim 1, wherein
the at least one controller is configured to determine, after the unmounting process terminates, whether the cartridge is removed from the interface unit, and also display warning until the cartridge is removed from the interface unit.

4. The head mounted display according to claim 2, wherein
the at least one controller is configured to determine, after the unmounting process terminates, whether the cartridge is removed from the interface unit, and also display warning until the cartridge is removed from the interface unit.
